(19) United States
(12) Patent Application Publication
(10) Pub. No.: US 2007/0002488 A1
(43) Pub. Date: Jan. 4, 2007

(54) Slide control device

(75) Inventor: Kojiro Kato, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/333,816

(22) Filed: Jan. 17, 2006

(30) Foreign Application Priority Data
Jul. 4, 2005 (JP) 2005-195236

(51) Int. Cl. G11B 5/027

(52) U.S. Cl. 360/85

(57) ABSTRACT

A slide control device capable of reducing an influence on sensor detection accuracy of a pressing force at a time of operation, and taking measures against a vertical load to the entire device. The slide control device has a fixed part and a moving part moving with respect to the fixed part, and outputs a moving signal by movement of the moving part with respect to the fixed part. A moving guide is provided at the fixed part along a longitudinal direction of thereof, and slidably holds the moving part. A sensing device senses an operation state in which the moving part moves along the moving guide. The sensing device has a detecting part that is provided at the moving part, senses the moving guide, and outputs the moving signal. The detecting part orients in an opposite direction to a direction to press the moving part when the moving part is moved.

### BACKGROUND OF THE INVENTION

1. Field of the Invention

The present invention relates to a slide control device suitable for setting parameters or the like by manipulating a slider or the like to slide a moving part.

2. Description of the Related Art

Conventionally, mixing consoles have been used in broadcasting stations, recording studios, concert halls and the like, and have performed various kinds of controls (signal processing) on a number of signals to output audio signals from various kinds of musical instruments, vocals and the like as monitors for players, monitors for mixers and the like. Therefore, a number of control knobs of various kinds are arranged on the control panels of mixing consoles, and it is demanded to reduce the load on operators by improving operability of the control panels.

For example, Japanese Patent Laid-open No. 9-198953 discloses a technique of marking a plurality of fader knobs with different colors such as red, green and yellow to make the positions of the fader knobs discernible by identifying the colors. In this way, the control knobs that can be visually identified by the colors may reduce the load on operators when they operate a number of control knobs.

In the meanwhile, a fader knob in which a knob thereof slides needs a guide rod (rod body) for guiding the knob and a sensing part for sensing the movement of the knob. The guide rod and the sensing part are constructed individually, and thus construction of the fader knob becomes complex.

Moreover, in a slide volume device in which sliders such as the fader knobs described above are operated, a predetermined pressing force is applied to the control knobs when the control knobs are operated. Especially when they are operated quickly, a strong pressing force is sometimes applied to them.

However, because the slide volume device detects with a sensor or the like a moved position of an internal moving part which moves simultaneously with a slider, the pressing force applied to the slider is likely to affect detection accuracy of the sensor. Further, a too strong pressing force in the vertical direction (vertical load) onto the slide volume device may cause breakage of the slide volume device itself. Furthermore, if the pressing force is too strong, the sensor cannot work well.

### SUMMARY OF THE INVENTION

It is an object of the present invention to provide a slide control device capable of reducing an influence on sensor detection accuracy of a pressing force at a time of operation, and taking measures against a vertical load to the entire device, in the slide control device which obtains a moving signal corresponding to an operation state by an operation of a slider or the like.

To attain the above described object, according to a first aspect of the present invention, there is provided a slide control device having a fixed part and a moving part moving with respect to the fixed part, and outputting a moving signal by movement of the moving part with respect to the fixed part, comprising a moving guide that is provided at the fixed part along a longitudinal direction of the fixed part, and slidably holds the moving part, and a sensing device that senses an operation state in which the moving part moves along the moving guide, wherein the sensing device has a detecting part that is provided at the moving part, senses the moving guide, and outputs the moving signal, and the detecting part orients in an opposite direction to a direction to press the moving part when the moving part is moved.

According to the construction of the above described first aspect of the present invention, the distance between the moving guide and the detecting part is kept even if the moving part is pressed and the moving guide bends, and therefore, detection accuracy of the detecting part such as a sensor is ensured. Operation feeling (sliding feeling) is improved, and the measure against the vertical load to the entire device is achieved. The “moving signal” means various kinds of signals corresponding to the moving state of the moving part, and may be any signal such as a pulse signal of which frequency is proportional to the moving speed of the moving part, a signal indicating the moving amount of the moving part, a signal indicating the moved position, a signal indicating the speed at the time of moving, and a signal indicating acceleration at the time of moving. In the first aspect of the present invention, the moving signal is the above described pulse signal, and the moving amount of the moving part, the moved position, the speed at the time of moving, and the acceleration at the time of moving may be obtained from the pulse signal.

Preferably, a marking treatment part on which a number of polarized magnetic poles are formed in a longitudinal direction of the moving guide is included in the moving guide, and the detecting part is a magnetic sensor that detects a magnetic field of the magnetic poles of the marking treatment part.

According to the construction of the first aspect of the above described present invention, detection is performed with a magnetic sensor, and therefore, detection accuracy does not reduce even if the sensing surface of the magnetic sensor and the portion where the magnetic poles are formed are contaminated, or dust enters the gap between the sensing surface and the portion where the magnetic poles are formed. Thus, the slide control device resistant to contamination and dust is obtained.

Preferably, a marking treatment part on which a dark and light pattern is formed in a longitudinal direction of the moving guide is included in the moving guide, and the detecting part is an optical sensor that optically detects a change in the pattern of the marking treatment part.

According to the construction of the above described first aspect of the present invention, the above described effect is obtained by the optical sensor.

Preferably, a light emitting element is provided at a slider mounted to the moving part.

According to the construction of the above described first aspect of the present invention, the function or the like which is assigned to the slide control device can be identified by color by light emission of the light emitting element provided at the slider, and therefore, enhancement can be achieved in operability such as an ability to quickly operate intuitively.

Preferably, a lead wire drawing port from which a lead wire connected to the detecting part is drawn out is provided in a center of the moving part with respect to a moving direction thereof.

According to the construction of the above described first aspect of the present invention, even if the inner lead wire bends as a result of the movement of the moving part, the bent portion of the inner lead wire does not have to be drawn outside from the lead wire drawing port, and the lead wire can be fixed (or temporarily fixed) at the outside portion from the lead wire drawing port. Therefore, the lead wire is not allowed to bend outside the slide control device.

Since the lead wire (flat cable or the like) is not dangling outside the lead wire drawing port, the slide control device is favorably housed in the inside the main apparatus accommodating the slide control device.

To attain the above described object, according to a second aspect of the present invention, there is provided a slide control device having a fixed part and a moving part moving with respect to the fixed part, and outputting a moving signal by movement of the moving part with respect to the fixed part, comprising a moving guide that is provided at the fixed part, and holds the moving part slidably along a longitudinal direction of the fixed part, and a detecting part that is provided at the moving part and senses the moving guide when the moving part moves in a longitudinal direction of the moving guide by being guided by the moving guide, wherein the moving part has an abutting part that abuts on the moving guide in a direction to press the moving part when the moving part is moved, and the detecting part is provided at the moving part to be opposed to the direction to press the moving part when the moving part is moved.

According to the construction of the above described second aspect of the present invention, the abutting part abuts on the moving guide to keep the distance between the detecting part and the moving guide even if the moving part is pressed, and detection accuracy of the detecting part is ensured. In addition, the operation feeling (sliding feeling) is improved, and the measure against the vertical load to the entire device is achieved. Two abutting parts are preferably provided to be separated in the moving direction, but only one abutting part may be adopted. The moving guide may be constructed by two bars.

To attain the above described object, according to the third aspect of the present invention, there is provided a slide control device comprising a main body part fixed to an electronic apparatus, and a moving part moved with respect to the main body part, and having a detector that outputs a moving signal by the moving part moving, comprising moving guide part of two bars comprising a first moving guide element and a second moving guide element that are fixed to the main body part and parallel with each other along a longitudinal direction of the main body part, wherein any one of the first and second moving guide elements has a marking treatment part to which marking treatment is applied in its longitudinal direction as a part of the detector, a detecting part that generates the moving signal by the moving part being moved while opposing the marking treatment part by moving in a longitudinal direction of the moving guide part by being guided by the moving guide part is provided at the moving part, the detecting part has a moving guide element opposing part that is opposed to the any one of the moving guide elements, and the any one of the moving guide elements has the marking treatment applied to an opposing surface to the moving guide element opposing part of the detecting part along its longitudinal direction.

In a third aspect of the present invention, “any one of the moving guide elements” is the moving guide element having the marking treatment part.

According to the construction of the above described third aspect of the present invention, the moving guide part comprised of the two bars that are the first and the second moving guide elements parallel with each other, the slide operation of the moving part becomes stable, and an influence on the detection accuracy of the sensor of the detector at the time of operation can be reduced.

Preferably, the detecting part is provided at the moving part to be opposed to a direction to press the moving part when the moving part is moved.

According to the construction of the above described third aspect of the present invention, the detecting part is provided at the moving part to be opposed to the pressing direction to the marking treatment part when moving the moving part. Therefore, even if bending occurs to the moving guide element with a strong pressing force, the guide element opposing part of the detecting part approaches the marking treatment part to act so as to enhance detection sensitivity of the detector, and bending or the like due to the above described pressing force does not have any influence on detection accuracy.

Preferably, the moving part has a first guide hole that allows the any one of the moving guide elements to penetrate therethrough, and a second guide hole that allows the other moving guide element to penetrate therethrough, and a clearance in a pressing direction between the first guide hole and the moving guide part is larger than a clearance in the pressing direction between the second guide hole and the moving guide part.

According to the construction of the above described third aspect of the present invention, the clearance in the pressing direction between the first guide hole (auxiliary hole) and the moving guide part is larger than the clearance in the pressing direction between the second guide hole (main guide hole) and the moving guide part. Therefore, even if bending occurs to the moving guide element with a strong pressing force, the auxiliary guide hole does not contact the marking treatment part, and wear or the like of the marking treatment part can be prevented. In addition, the guide element opposing part of the detecting part approaches the marking treatment part to act to enhance detection sensitivity of the detector, and therefore, bending or the like by the above described pressing force does not affect detection accuracy.

More preferably, the clearance in the pressing direction between the second guide hole and the moving guide part is smaller than the clearance in the pressing direction between the first guide hole and the moving guide part.

According to the construction of the above described third aspect of the present invention, back-lash in the pressing direction of the moving part due to the clearance between the second guide hole and the corresponding moving guide element is eliminated, and thus, the operability of the slide operation is improved. In addition, the clearance in the lateral direction between the first guide hole and the corresponding moving guide element (any one of the moving-guide elements) is made small, and swing in the lateral direction of the moving part can be prevented.

Preferably, the any one of the moving guide elements comprises a main part with a non-magnetic element in a bar shape having rigidity as a main shaft, and an auxiliary part as a marking treatment part to which a magnetized scale provided along a longitudinal direction of the main part is applied.

According to the construction of the above described third aspect of the present invention, in the above described any one of the moving guide elements, the main part is in the bar shape with rigidity, and therefore, while fragility of, for example, ferrite or the like is supplemented, the intensity of the magnetism of the magnetized scale of the marking treatment part can be ensured by the auxiliary part. Therefore, the rigid slide control device having stable detection accuracy can be obtained.

The above and other objects, features, and advantages of the invention will become more apparent from the following detailed description taken in conjunction with the accompanying drawings.

### BRIEF DESCRIPTION OF THE DRAWINGS

FIGS. 1A, 1B and 1C are views showing a main part of a moving block of a slide volume device as a slide control device according to a first embodiment of the present invention;

FIG. 2 is an exploded perspective view showing a main part of the same slide volume device;

FIGS. 3A and 3B are views showing a main part of a slide volume device as a slide control device according to a second embodiment of the present invention;

FIG. 4 is a view explaining a clearance between a magnetic sensor and a moving guide in this embodiment;

FIG. 5 is a sectional view showing a modified example of the moving guide in this embodiment;

FIGS. 6A, 6B and 6C are views showing a main part of a slide volume device as a slide control device according to a third embodiment of the present invention;

FIG. 7 is a perspective view showing a main part of a slide volume device as a slide-control device according to a fourth embodiment of the present invention;

FIGS. 8A and 8B are views showing a main part of a moving block in this embodiment, FIG. 8A is a perspective view of the moving block, and FIG. 8B is a sectional view of an auxiliary moving guide element in FIG. 8A;

FIG. 9 is a view showing a partial side surface of the moving block and a section of a main moving guide element and the auxiliary moving guide element in this embodiment;

FIG. 10 is a view explaining a lateral swing prevention mechanism of the moving block in this embodiment;

FIG. 11 is a general view of a panel surface of a mixing console to which a slide volume device as the slide control device according to each of the embodiments of the present invention is applied;

FIG. 12 is a circuit diagram of a parameter setting device using the slide volume device as the slide control device according to the first embodiment; and

FIG. 13 is another circuit diagram of the parameter setting device using the same slide volume device.

### DETAILED DESCRIPTION OF THE PREFERRED EMBODIMENTS

Hereinafter, embodiments of the present invention will be described with reference to the drawings.

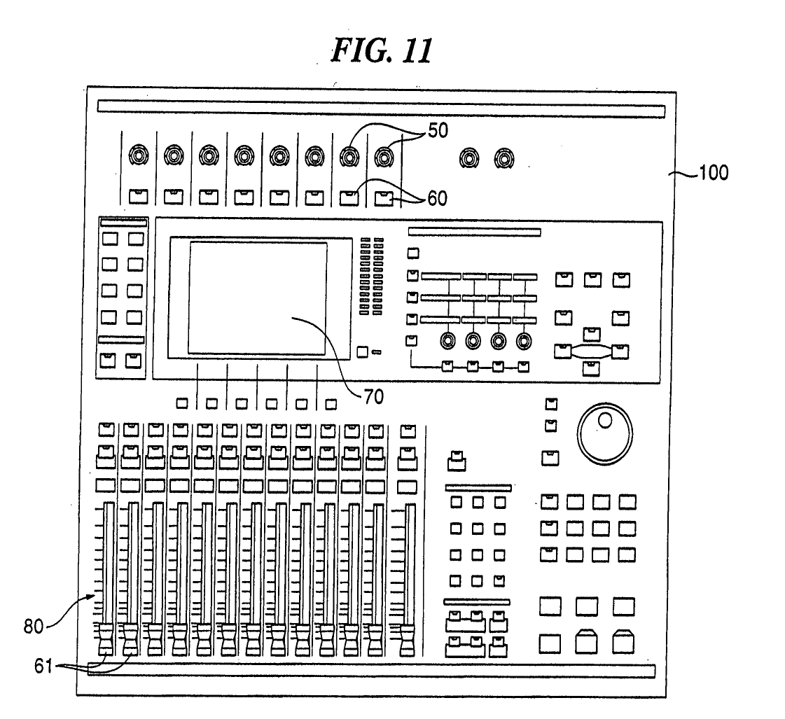

FIG. 11 is a general view of a panel surface 100 of a mixing console using a slide control device (slide volume device in a first to a fourth embodiments) according to each of the embodiments which will be described later. The vertical and lateral directions in the explanation of the panel surface 100 correspond to the vertical and lateral directions in the state in which the panel surface 100 is seen from the front. The panel surface 100 is provided with volume control knobs 50 which adjust input levels of monaural input channels of microphone input, line input and the like, operating buttons 60 of channel-on switches, a liquid crystal display 70 which displays a setting content of the input channels and the like, a slider group 80 comprised of a plurality of sliders 61 which individually respond to the slide control devices of the present embodiments, and the like.

The slide control group 80 is used for setting various kinds of parameters, for example, by setting each parameter corresponding to filter characteristics by being used as a graphic equalizer to set frequency characteristics of input signals and output signals, by setting parameters by being used as a fader which adjusts an input level and an output level, and the like. Namely, a number of parameters can be set by selecting a function of the slide control group 80 from a plurality of functions and switching to it.

### First Embodiment

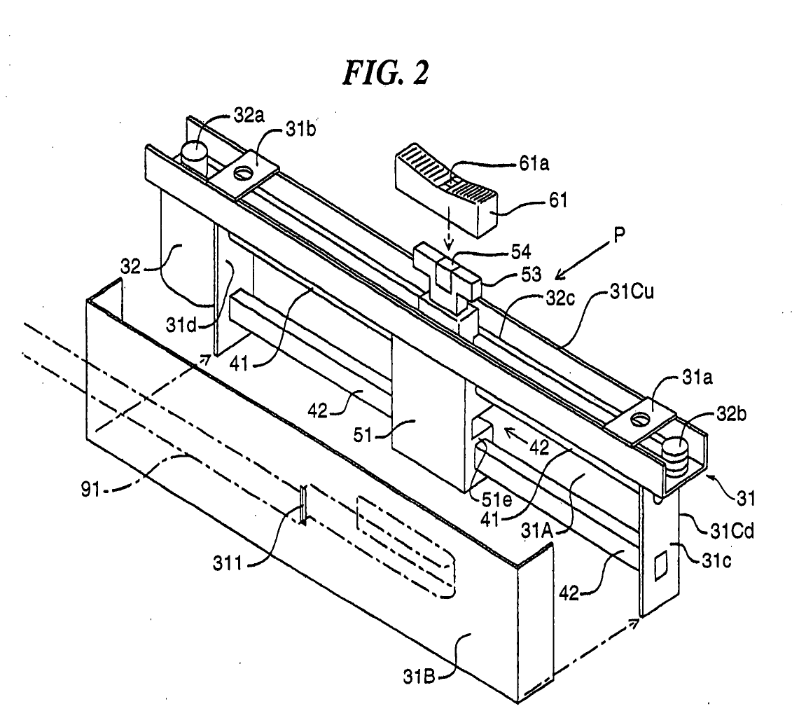

FIG. 2 is an exploded perspective view showing a main part of a slide volume device as a slide control device according to the first embodiment of the present invention. In this slide volume device, a frame 31 as “fixed part” is formed by side plates 31A and 31B which form perpendicular surfaces to the above described panel surface 100 on its back side, and two frames 31Cu and 31Cd which are u-shaped in section. The frame 31Cd is mounted so as to surround upper ends and both ends of the side plates 31A and 31B from above, and the frame 31Cu is mounted on the frame 31Cd. A motor 32 is mounted to one end of the upper frame 31Cu, and the entire frame 31 is mounted to a back surface of the panel surface 100 by fastening plates 31a and 31b provided in the vicinity of both ends of the upper frame 31Cu. A first moving guide 41 and a second moving guide 42 which are parallel with each other along a longitudinal direction of the side plate 31A are mounted to bridge both end surfaces 31Cu and 31d of the lower frame 31Cd. The first moving guide 41 is a metal member in the shape of a round bar, and the second moving guide 42 is a metal member in the shape of a square bar. A moving block 51 as “a moving part” is mounted to the first and the second moving guides 41 and 42 to be slidable along a longitudinal direction of the moving guides 41 and 42. In this embodiment, “both the first and the second moving guides” or “the second moving guide” corresponds to “moving guide” in What is claimed.

A driving pulley 32a is mounted to a drive shaft of the motor 32 arranged at one side of the frame 31Cu, and a driven pulley 32b is arranged at the other end of the frame 31Cu. A timing belt 32c is wound around the driving pulley 32a and the driven pulley 32b, and an upper portion of the moving block 51 is mounted to one spot of the timing belt 32c. Thereby, the moving block 51 reciprocally moves along the longitudinal direction of the first and the second moving guides 41 and 42 by normal and reverse rotation of the motor 32. The reciprocal motion is, for example, the motion when the position of the slider 61 is automatically set so as to correspond to the parameter when a different channel is assigned to the slide volume device (fader) or the slide volume device is assigned to a different function.

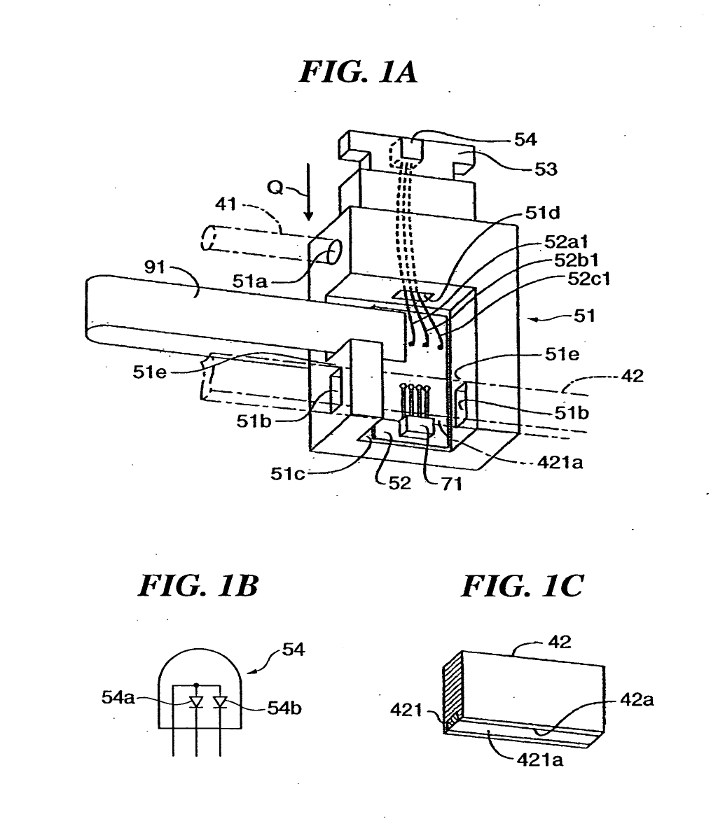

FIG. 1A is a perspective view showing a main part of the moving block 51, and shows the state seen in the direction of the arrow P in FIG. 2. In the moving block 51, a shaft hole 51a in which the first moving guide 41 is inserted, and shaft holes 51b and 51b in which the second moving guide 42 are inserted are formed, and a board housing part 51c is formed as a recessed surface separated from the second moving guide 42. The board housing part 51c is the part where a board 52 to which a magnetic sensor 71 that will be described later is fastened is fixed, and one end of a flat cable 91 as well as lead wires 52a1, 52b1 and 52c1 are connected to the board 52. The lead wires 52a1, 52b1 and 52c1 pass through a through-hole 51d and are connected to a multi-color LED element 54 which is mounted to a lever 53. As shown in FIG. 2, the slider 61 which has a light guide 61a opposed to an upper light-emitting surface of the multi-color LED element 54 is mounted to the lever 53. The multi-color LED element 54 and the light guide 61a correspond to “light emitting element”

As shown in FIG. 1C, a groove 42a is formed along substantially entire length in the longitudinal direction on an undersurface of the second moving guide 42, and a rubber magnetic member 421 is filled in the groove 42a. In the magnetic member 421, magnetic poles are formed by finely (for example, at the intervals of 400 μm) polarizing the north pole and the south pole alternately in the longitudinal direction (a so-called “magnescale”). Alternatively, the second moving guide 42 itself, which is provided with no groove, may form a ferrite magnet comprised of a metal oxide. A pattern formed by these magnetic poles corresponds to “marking treatment part”The magnetic sensor 71 (or an MR sensor) as “a detector” formed by an IC or the like including a hall element is loaded on the board 52, and a sensing surface of the magnetic sensor 71 is opposed to a pole-face 421a of the magnetic member 421 with a small gap (space) provided therebetween. Further, output lines of the magnetic sensor 71 and the lead wires 52a1, 52b1 and 52c1 of the above described multi-color LED element 54 are connected to an outside via the flat cable 91 which is mounted to the board 52. The multi-color LED element 54 emits light by an electric current which is supplied from the flat cable 91. The magnetic sensor 71 is energized via the flat cable 91, and a detection signal of the magnetic sensor 71 (“moving signal”) is transmitted to an unshown circuit via the flat cable 91.

When the magnetic sensor 71 moves along the pole-face 421a of the magnetic member 421 simultaneously with the moving block 51, the magnetic sensor 71 outputs pulse signals corresponding to reversals of the polarities of the north pole and the south pole of the pole-face 421a. The moving amount (length) of the moving block 51 can be detected according to the number of the pulse signals. The magnetic poles of the pole-face 421a is comprised of, for example, two rows, and the patterns of these magnetic poles are shifted by the amount equivalent to ½ π from each other in their phases in the longitudinal direction of the second moving guide 42. The magnetic sensor 71 outputs a pulse signal shifted in phase, and therefore, the moving direction of the moving block 51 is determined by the direction of the phase shift. Alternatively, the magnetic pole pattern may be comprised of the pattern of NS NS . . . without a phase shift, and the detecting pole part of the sensor may be disposed with a phase shift by the amount equivalent to ½ π. Further, the positional information of the position before the moving block 51 moves is always stored by a control circuit not shown or the like, and therefore, by the positional information and the above described moving amount and moving direction, the position of the moving block 51 in the entire slide volume device, namely, the position of the slider 61 is detected.

Here, when the moving block 51 is moved (slid) by manually operating the slider 61, the moving block 51 is generally pressed in a direction of the arrow Q in FIG. 1A (“direction to press” in What is claimed). Upper portions of the shaft holes 51b and 51b of the moving block 51 are abutting parts 51e which abut on an upper end surface (surface at an opposite side from the magnetic member 421) of the above described second moving guide 42 in the pressing direction. When the moving block 51 is pressed with a small force, the moving block 51 is not lowered by the first and the second moving guides 41 and 42, and even if the moving block 51 is lowered when it is pressed with a strong force, the second moving guide 42 also lowers via the abutting part 51e. Therefore, the gap (space) between the pole-face 421a of the magnetic member 421 of the second moving guide 42 and the sensing surface of the magnetic sensor 71 is kept constant. When the above described gap varies, the level or the like of the detection signal changes to reduce detection accuracy, but the gap is kept constant, whereby a stable signal can be obtained as the detection signal of the magnetic sensor 71, and detection accuracy is ensured.

As above, the magnetic sensor (detector) 71 senses the second moving guide 42 which holds the moving block (moving part) 51 provided with the magnetic sensor 71, and therefore, detection accuracy is improved more remarkably than the case where, for example, the magnetic sensor detects a marking treatment part or the like provided at the side plate 31A (or 31B) or the like of the frame 31. Namely, when the marking treatment part provided at the side plate 31A (or 31B) or the like is detected like this, if the moving block 51 is lowered by the pressing force, the gap changes to affect the detection accuracy, but in the above described embodiment, such a thing does not happen.

Since in the above described embodiment, detection is performed with the magnetic method, the detection accuracy does not reduce even if the sensing surface of the magnetic sensor 71 and the magnetic surface 421a of the magnetic member 421 are contaminated, and dust enters the gap, and the slide volume device resistant to contamination and dust is provided.

As shown in FIG. 2, in the side plate 31B, a lead wire drawing port 311 which is vertically longer is formed in a center of the moving direction of the moving block 51 (center in the longitudinal direction of the side plate 31B). The flat cable 91 (lead wire) which is connected to the above described magnetic sensor 71 and the multi-color LED element 54 is drawn out from the board 52 and folded back at 180°, and further drawn outside the side plate 31B from the lead wire drawing port 311. Namely, since the lead wire drawing port 311 is located in the center, the length of the flat cable 91 which is arranged inside the side plate 31B from the lead wire drawing port 311 needs to be only substantially a half of the entire sliding range of the moving block 51. The flat cable 91 is arranged by being further folded back, and therefore, the flat cable 91 can be easily housed in the case 31. Therefore, the flat cable 91 can be lightly fixed at a portion of the lead wire drawing port 311, and even when the moving block 51 moves, the flat cable 91 is not dangling like a cable connected to the head of an ordinary printer when seen from the outside of the side plate 31B. Therefore, the flat cable 91 can be favorably housed in the mixing console of the slide volume device.

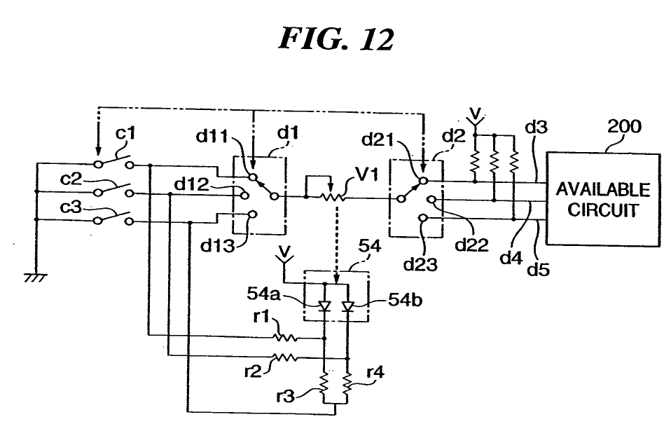

FIG. 12 is a circuit diagram of a parameter setting device using the above described slide volume device. This circuit is a circuit for switching the function of the slide volume device to any one of a plurality (three in this example) of different functions and setting it, and includes switch circuits c1, c2 and c3 which interlock with function selecting switches not shown, and selector circuits d1 and d2. Though FIG. 12 shows a circuit as the circuit corresponding to one slide volume device in FIG. 12, and each of the circuits corresponding to a plurality of slide volume devices corresponding to a plurality of control knobs 61 of the above described slider group 80 also has the same construction. The same function selected by the function selecting switch is also set for the other slide volume devices. Hereinafter, one slide volume device will be described.

One terminal of each of the switch circuits c1, c2 and c3 is grounded (earthed), and the other terminals are respectively connected to selection terminals d11, d12 and d13 of the selector circuit d1. A volume circuit V1 is connected to the common contact of the selector circuits d1 and d2. The volume circuit V1 is an electronic volume of which resistance is set in accordance with a detection signal in the above described slide volume device. Selection terminals d21, d22 and d23 of the selector circuit d2 are connected in parallel to reference voltage and an available circuit 200. Signal lines d3, d4 and d5 connected in parallel to the available circuit 200 respectively supply voltage signals to required spots in the available circuit 200 as parameters in accordance with the functions (1), (2), and (3). One terminal of each of a red LED 54a and a green LED 54b of the above described multi-color LED element 54 are connected to the reference voltage, and the respective other terminals are grounded via resistors r1 and r2, and the switch circuits c1 and c2, and are commonly grounded via resistors r3 and r4, and the switch circuit c3.

When the function (1) is selected, the switch circuit c1 is turned on (closed), and the selection terminal d11 of the selector d1 and the selection terminal d21 of the selector d2 are respectively connected to the volume circuit V1. When the function (2) is selected, the switch circuit c2 is turned on (closed), and the selection terminal d12 of the selector d1 and the selection terminal d22 of the selector d2 are respectively connected to the volume circuit V1. Further, when the function (3) is selected, the switch circuit c3 is turned on (closed), and the selection terminal d13 of the selector d1 and the selection terminal d23 of the selector d2 are respectively connected to the volume circuit V1. Therefore, a voltage signal corresponding to the resistance value of the volume circuit V1 occurs by the operation of the slide volume device, and the voltage signal is supplied to the available circuit 200 from the signal line d3 in the case of the function (1), from the signal line d4 in the case of the function (2), and from the signal line d5 in the case of the function (3) respectively.

In the case of the function (1), only the red LED 54a lights up, and in the case of the function (2), only the green LED 54b lights up. In the case of the function (3), both the red LED 54a and the green LED 54b light up. Thereby, the light guide 61a of the slider 61 emits light of “red” in the case of the function (1), light of “green” in the case of the function (2), and light of “yellow (red+green)” in the case of the function (3), and in accordance with the color of the emission light of the light guide 61a, it can be easily recognized which function is selected at present.

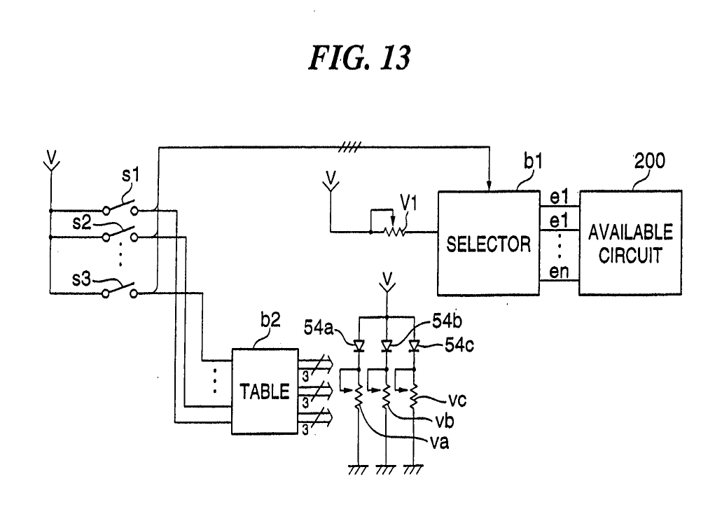

In the above described embodiment, the case where the multi-color LED element 54 has two LEDs that are the red LED 54a and the green LED 54b, but the multi-color element including three colors of the red LED 54a, the green LED 54b and a blue LED 54c may be used. In this case, by controlling luminance of each LED, the LEDs are caused to emit light in many colors, which is suitable for the case of selecting a number of functions. FIG. 13 is a circuit diagram of a parameter setting device in the case of selecting a number of functions. Switch circuits s1, s2, . . . , and sn which correspond to a plurality of control knobs not shown for selecting functions are connected in parallel to the reference voltage V, and on-signals of these switch circuits s1, s2, . . . , and sn are H-level signals, and off-signals are L-level signals. These on/off signals are inputted into a selector b1 and a table b2 as a bit signal of a plurality of bits. The switch circuits s1, s2, . . . , and sn are turned on in an alternative way in accordance with the corresponding control knobs, and in this bit signal, one bit is at an H level and the other bits are at an L level.

The volume circuit V1 which is driven by the above described slide volume device is connected to the reference voltage V, and a volume signal corresponding to the resistance value of the volume circuit V1 is inputted into the selector b1. Outputs e1, e2, . . . , and en of the selector b1 respectively correspond to the switch circuits s1, s2, . . . , and sn, and the selector b1 selects the outputs e1, e2, . . . , and en in an alternative way in accordance with the bit signals from the switch circuits s1, s2, . . . , and sn, and supplies the voltage signal of the volume circuit V1 to the available circuit 200 in accordance with the output corresponding to the selected function.

Meanwhile, the table b2 is a circuit which converts the bit signal inputted from the switch circuits s1, s2, . . . , and sn into, for example, three bit signals each comprised of three bits, and the outputted three bit signals become the bit signals corresponding to the color assigned to the function selected in the switch circuits s1, s2, . . . , and sn. The three bit signals each with three bits are respectively supplied to electronic volume circuits va, vb, and vc which control supply current to the red LED 54a, the green LED 54b, and the blue LED 54c. Thereby, the red LED 54a, the green LED 54b and the blue LED 54c each emit light with luminance indicated by each of the corresponding bit signals. In this example, each bit signal is of three bits, which is the numeric value data corresponding to the luminance of “0 to 7”, and by the combination of the luminance of the three colors of the red LED 54a, the green LED 54b and the blue LED 54c, light in 512 colors can be emitted including no light (black).

### Second Embodiment

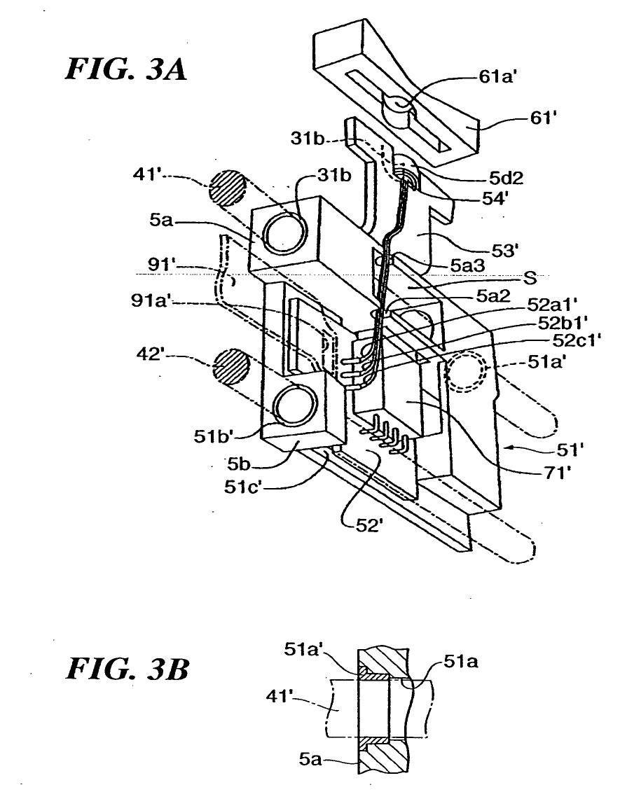

FIG. 3A is a perspective view showing a main part of a slide volume device as a slide control device according to a second embodiment of the present invention, and corresponds to the state of the first embodiment seen in the direction of the arrow P in FIG. 2. The elements corresponding to the elements of the first embodiment are given the same reference numerals as those of the first embodiment and “′” is added to the same reference numerals. In the second embodiment, both of two moving guides 41′ and 42′ are metal members each in the shape of a round bar, and a moving block 51′ as “a moving part” is mounted to the first and the second moving guides 41′ and 42′ so as to be slidable in a longitudinal direction of the first and the second moving guides 41′ and 42′. In the second embodiment, the frame 31 which is constructed by the above described side plates 31A and 31B, and the frames 31Cu and 31Cd is also “the fixed part”.

The moving block 51′ in the second embodiment has a rectangular space (hole) S formed in a center of an upper guide holding part 5a. The space S facilitates formation of the moving block 51′, but it may be omitted. As partially shown in FIG. 3B, holding holes 5a1 which penetrate through the space S are respectively formed at both ends of the guide holding part 5a, and holding rings 51a′ and 51a′ are mounted to the holding holes. The moving block 51′ has a board holding part 51c′ at a lower side from an undersurface side portion of the guide holding part 5a, and a holding hole is formed in a guide holding part 5b which is provided at one side of a lower portion of the board holding part 51c′ and a holding ring 51b′ is mounted to the holding hole. The first moving guide 41′ is inserted so as to penetrate through the guide holding part 5a via the holding rings 51a′ and 51a′ and the space S. The second moving guide 42′ is inserted so as to penetrate through the guide holding part 5b via the holding ring 51b′. Inner surfaces of the respective holding rings 51a′, 51a′ and 51b′ are finished to be smooth, so that the moving block 51′ smoothly moves along the moving guides 41′ and 42′.

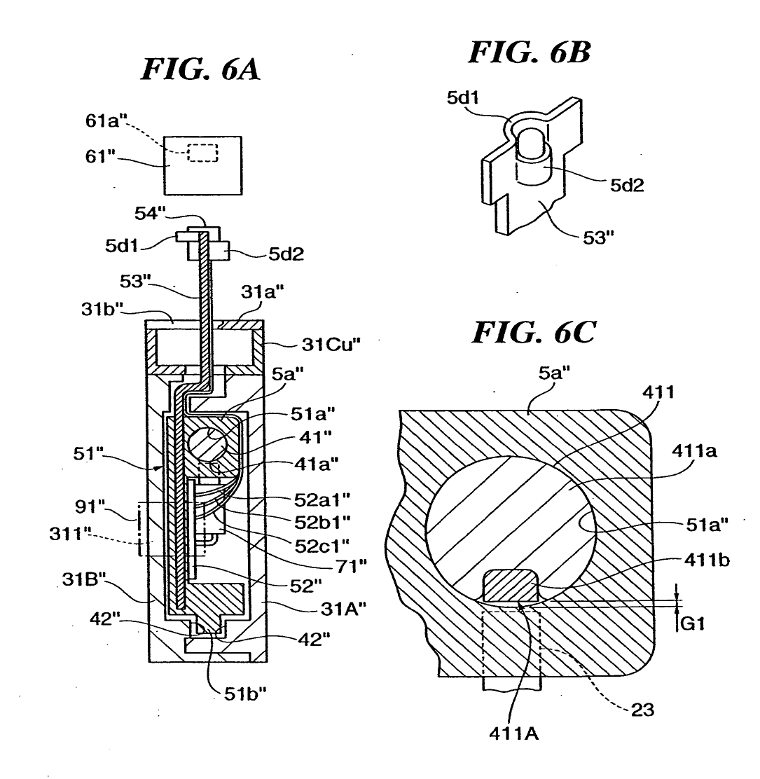

A board 52′ is mounted to the board holding part 51c′, and a magnetic sensor 71′ as “a detector” is mounted to the board 52′. One end of a flat cable 91′ is connected to the board 52′ via a terminal part 91a′, and lead wires 52a1′, 52b1′ and 52c1′ are connected to the board 52′. LED holding parts 5d1 and 5d2 are formed at an upper end of a lever 53′, and a multi-color element 54′ is mounted to the LED holding parts-5d1 and 5d2. As shown in FIG. 6B (third embodiment) which will be described later, the LED holding parts 5d1 and 5d2 are constructed into the shapes of semi-circular arcs on-vertically different levels. The lead wires 52a1′, 52b1′ and 52c1′ are bonded to and locked at recessed parts 5a2 and 5a3 provided at opposing portion of the guide holding part 5a for the frame 31A with a rubber adhesive to be strippable, and the lead wires are guided to the LED-holding part 5d2 and connected to the multi-color LED element 54′. A slider 61′ having a light guide 61a′ which is opposed to an upper light emitting surface of the multi-color LED element 54′ is mounted to the lever 53′. The multi-color LED element 54′ and the light guide 61a′ correspond to “a light emitting element”.

An output line of the magnetic sensor 71′ and the lead wires 52a1′, 52b1′ and 52c1′ of the multi-color LED element 54′ are connected to an outside via the flat cable 91′ which is mounted to the board 52′. The flat cable 91′ is also drawn outside the lead wire drawing port 311 as in the first embodiment, and therefore, the same effect as the first embodiment is obtained. It is the same as the first embodiment that energization of the multi-color LED element 54′ and the magnetic sensor 71′ and extraction of the detection signals from the magnetic sensor 71′ are performed via the flat cable 91′. As will be described later, a plurality of magnetic poles are formed as a marking treatment-part in the first moving guide 41′, and the position of the moving block 51′ (slider 61′) is detected by the detection signal of the magnetic sensor 71′.

The first moving guide 41′ is made of an alloy in which nickel and cobalt are mixed in iron used as a base material. Thereby, the first moving guide 41′ can retain the nature of iron itself as it is, and is difficult to fold and has resilience which make it return to the original shape even if it is slightly bent. Namely, the first moving guide 41′ is tougher even if a pressing force is applied thereon than when a fragile ferrite magnet itself is used as the guide, and can prevent breakage of the slide volume device.

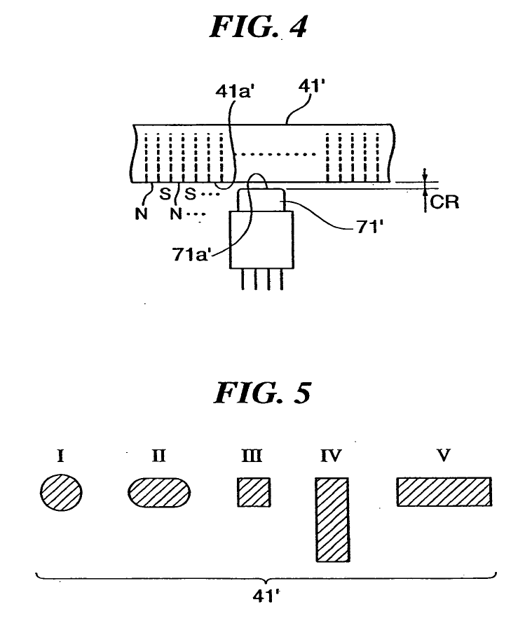

Further, as shown in FIG. 4, the first moving guide 41′ is the magnet in which a number of magnetic poles are formed by alternately forming the north poles and the south poles finely as the marking treatment part as in the first embodiment. For example, the magnetic poles are high-resolution magnets with a space between north poles being 100 μm pitch (50 μm between the north pole and the south pole). The magnetic sensor 71′ is formed by an IC including a hall element, or the like (or an MR sensor), and a sensing surface 71a′ of the magnetic sensor 71′ is opposed to a pole-face 41a′ of the first moving guide 41′ with a small clearance CR (space) of, for example, about 0.1 to 0.2 mm provided therebetween. The magnetic field of the pole-face 41a′ is detected by the magnetic sensor 71′, and the detection signal (moving signal) is obtained. Namely, the first moving guide 41′ and the magnetic sensor 71′ construct sensing device.

Here, the magnetic sensor 71′ senses the first moving guide 41′ itself which holds the moving block 51′ provided with the magnetic sensor 71′. Therefore, if the moving guide 41′ is slightly bent by a pressing force to lower the moving block 51′, the above described clearance CR is always constant, and therefore, an influence on the detection accuracy by the pressing force can be eliminated as in the first embodiment.

Further, as shown by the dotted line in FIG. 4, the magnetic poles of the moving guide 41′ are formed so as to exhibit stronger magnetization on the pole-face 41a′ than the inside of the moving guide 41′. Here, the clearance CR is constant, and therefore, the clearance CR itself can be made small. When the clearance CR is made small, if the sensitivity of the magnetic sensor 71′ is set at the same sensitivity as when the clearance CR is large, magnetization may be weaker than when the clearance CR is made large. Namely, the intensity of magnetization of the pole-face 41a′ may be low. The intensity of magnetization may be only magnetization of the minimum magnetic force with which a dead zone and a non-operate zone of sensing by the magnetic sensor 71′ and the pole-face 41a′ do not occur with an ordinary pressing force or at the time of an ordinary operation, and even when a strong pressing force is applied as described above, stable sensing can be obtained. Enhancement of sensitivity and detection accuracy is realized by making the clearance CR small like this. Since a clearance between the second moving guide 42′ and the moving block 51′ does not have an influence on sensitivity and accuracy even if it is large, the positional relationship between the second moving guide 42′ and the moving block 51′ may be designed roughly to some extent, and therefore, cost can be reduced.

FIG. 5 is a sectional view showing a modified example of the moving guide. The shape of the round bar shown in (I) corresponds to the moving guide 41′ of the second embodiment. (II) shows the shape of the oblong bar which is laterally flat, (III) shows the shape of the square bar with a quadrate section, (IV) shows the shape of a long plate with a section in a vertically oriented rectangle, and (V) shows the shape of a long plate with a section in a laterally oriented rectangle. The moving block is provided with a holding hole which conforms to each sectional shape of these moving guides corresponding to each of the modified examples, and especially in the case of (IV) and (V), only one moving guide is needed. This is because the second moving guide 42′ plays an auxiliary role of preventing the moving block 51′ from turning in the lateral direction with the first moving guide 41′ as the shaft, but in the case of the above described (IV) and (V), the turning of the moving block can be restrained with only one moving guide, and the second moving guide 42′ or the like is not required.

The first moving guide 41′ is the moving guide which is tough because it is made of the alloy with nickel and cobalt mixed in iron used as the base material, but it may be formed by placing soft iron up and sticking a ferrite magnet to an undersurface of the soft iron. In this manner, any moving guide of (II) to (V) shown in FIG. 5 can be easily produced. Since as for the magnetizing method, magnetization has to be applied only to the surface opposed to the magnetic sensor, and by contriving sticking, the magnetic force of the lower ferrite magnet does not reduce. For example, the first moving guide 41′ has only 3% of the lower part magnetized, and hardly has a magnetic force on the top surface. The first moving guide 41′ may be constructed to be rigid by insert-molding of a stainless steel shaft with high rigidity and a magnetic member as in a fifth embodiment which will be described later. Thereby, the fragility of ferrite or the like can be supplemented and intensity of magnetism can be secured.

In the above described second embodiment, the guide holding part 5b and the holding ring 51b′ has the structure fitted on the entire periphery of the second moving guide 42′, but even if any one of both left and right sides of the guide holding part 5b (and the holding ring 51b′) is opened to the moving guide 42′, the moving guide 42′ does not remove from the guide holding part 5b because the side plates 31A and 31B exist. The lower portion of the guide holding part 5b (and the holding ring 51b′) may be opened. In this manner, assembly is facilitated. Further, the holding ring 51b′ of the lower guide holding part 5b may be omitted.

### Third Embodiment

FIG. 6A is a sectional view showing a main part of a slide volume device as a slide control device according to a third embodiment of the present invention, and corresponds to a section in the view of the arrow A in FIG. 2. The elements corresponding to the elements of the first and the second embodiments are given the same reference numerals as those of the first and the second embodiments and “″” is added to each of the same reference numerals. In FIG. 6C, a sectional view of a moving guide in a slide control device according to a fifth embodiment of the present invention is also shown. In the third embodiment, a moving guide 41″ is made of the alloy in which nickel and cobalt are mixed in iron used as the base material, as in the first-moving guide 41′ in the second embodiment, and magnetization is performed to form a pole-face 41a″. The moving guide 41″ penetrates through a shaft hole 51a″ which is formed in a guide holding part 5a″ of a moving block 51″, and the moving block 51″ is held slidably in the direction orthogonal to FIG. 6A. A protruded ridge part 51b″ is formed at a lower portion of the moving block 51″, and side walls 42″ and 42″ which are respectively opposed to the protruded ridge part 51b″ are respectively formed at lower portions of side plates 31A″ and 31B″. The side walls 42″ and 42″ guide the protruded ridge part 51b″ of the moving block 51″ in the direction orthogonal to FIG. 6A to play the same role as the second moving guide 42′ of the second embodiment.

A board 52″ is mounted to the moving block 51″, and a magnetic sensor 71″ is mounted to the board 52″. Lead wires 52a1″, 52b1″, and 52c1″ which are connected to the board 52″ are laid along a lever 53″, and are connected to a multi-color LED element 54″ which is mounted to the LED-holding parts 5d1 and 5d2 at an upper end of the lever 53″. A slider 61″ having a light guide 61a″ which is opposed to an upper light emitting surface of the multi-color LED element 54″ is mounted to the lever 53″. The multi-color LED element 54″ and the light guide 61a″ correspond to a “light emitting element”.

The magnetic sensor 71″ is opposed to the pole-face 41a″ of the moving guide 41″ through an open hole not shown of the moving block 51″. A metal frame 31Cu″ is mounted to upper portions of the side plates 31A″ and 31B″, and the slide volume device of this embodiment is fixed to the back surface of the panel surface 100 by fastening plates 31a″ and 31b″ of the frame 31Cu″. One end of the flat cable 91″ is connected to the base plate 52″. The flat cable 91″ is also drawn outside a lead wire drawing port 311″ which is formed in a center of the side plate 31B″ in the moving direction of the moving block 51″ as in the first embodiment, and therefore, the same effect as in the first embodiment can be obtained. It is the same as in the second embodiment that energization of the multi-color LED element 54″ and the magnetic sensor 71″, and extraction of a detection signal from the magnetic sensor 71″ are performed via the flat cable 91″.

Since the magnetic sensor 71″ also senses the moving guide 41″ itself which holds the moving block 51″ in the third embodiment, a clearance between the magnetic sensor 71″ and the pole-face 41a″ is always constant even if the moving guide 41″ slightly bens by a pressing force, and an influence on detection accuracy by the pressing force can be eliminated.

In the third embodiment, the side plates 31A″ and 31B″ are constructed of a resin and reduction in weight can be achieved. Since a clearance between the side walls 42″ and 42″ which play the role of the second moving guide and the protruded ridge part 51b″ of the moving block 51″ does not have an influence on sensitivity and accuracy even if the clearance is large, the side plates 31A″ and 31B″ are constructed of a resin and may be roughly designed to some extent, and cost can be reduced. Since the resin side plates 31A″ and 31B″ can be fitted to each other and fastened with only one screw, the structure is simple and the manufacture is facilitated.

In place of the second moving guide in the second embodiment, in the above third embodiment, the side walls 42″ and 42″ and the protruded ridge part 51b″ are provided, but, for example, both the side plates may be formed of a metal plate, then protruded ridges bulged inward are respectively formed at both the side plates by drawing of the metal, and the protruded ridges may be slid in contact with the side surface of the moving block to guide the moving block.

In each of the slide volume devices of the above second embodiment and the third embodiment, it is the same as in the first embodiment that emitting light colors of the multi-color LED elements 54′ and 54″ are controlled by the circuits in FIG. 12 or FIG. 13 to facilitate confirmation of the function set in each of the slide volume devices.

### Fourth Embodiment

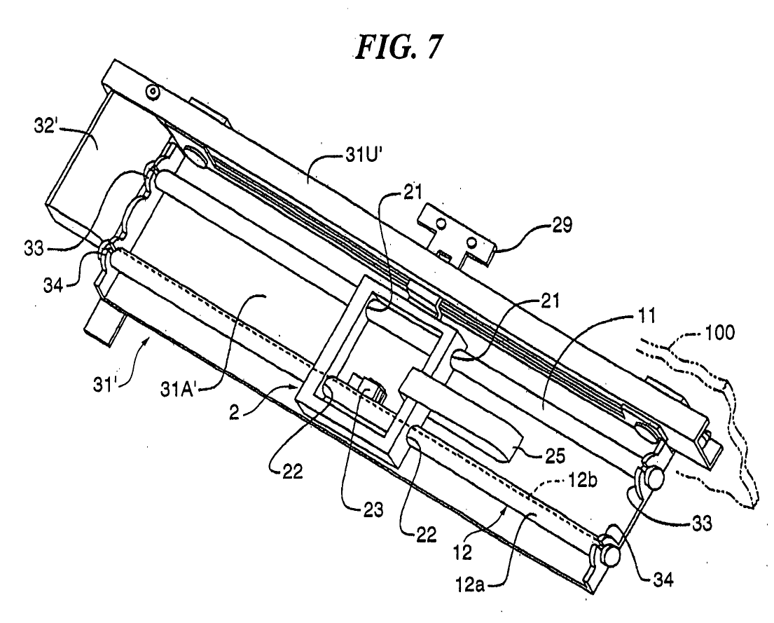

FIG. 7 is a perspective view showing a main part of a slide volume device as a slide control device according to a fourth embodiment of the present invention. In this embodiment, an auxiliary moving guide element 12 is “any one of the moving guide elements” and a main moving guide element 11 is “the other moving guide element”. An auxiliary guide hole 22 is “a first guide hole”, and a main guide hole 21 is “a second guide hole”. In this slide volume device, a frame 31′ as “a main body part” is formed by a side plate 31A′ which forms a perpendicular surface on a back side of the panel surface 100 with respect to the above described panel surface 100, and an upper frame 31U′ which is U-shaped in section. A mixing console of which panel surface 100 is shown in FIG. 11 corresponds to “electronic apparatus”. A motor 32′ is mounted to one end of the upper frame 31U′. Main guide element claws 33 and 33 and auxiliary guide element claws 34 and 34 are raised by bending at both ends of the side plate 31A′, and the main moving guide element 11 is mounted to bridge the main guide element claws 33 and 33, and the auxiliary moving guide element 12 is mounted to bridge the auxiliary guide element claws 34 and 34. The main moving guide element 11 and the auxiliary moving guide element 12 construct “a moving guide part” comprised of two bars which are parallel with each other along a longitudinal direction of the side plate 31A′.

The main moving guide element 11 is a stainless steel shaft in the shape of a round bar, and the auxiliary moving guide element 12 is constructed by a member in the shape of a round bar which is made by insert-molding a magnetic member into a non-magnetic stainless steel shaft as will be described later. A moving block 2 as “a moving part” is mounted to the main moving guide element 11 and the auxiliary moving guide element 12 to be slidable in the longitudinal direction of the main moving guide element 11 and the auxiliary moving guide element 12. A lever 29 in which a control knob not shown is fitted is mounted to the moving block 2. As in each of the above described embodiments, in order to automatically set the position of the slider of the slide volume device, the motor 32′ causes the moving block 2 to reciprocally move.

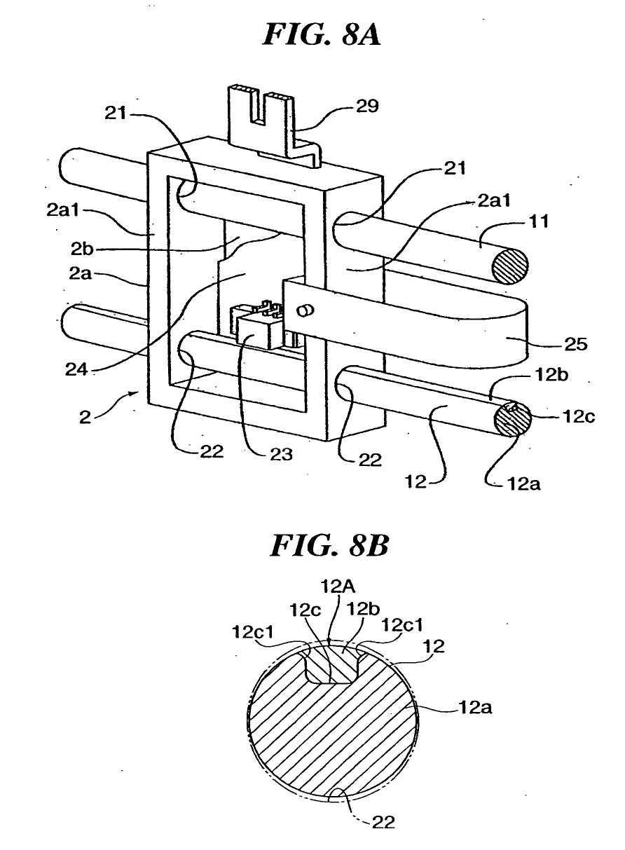

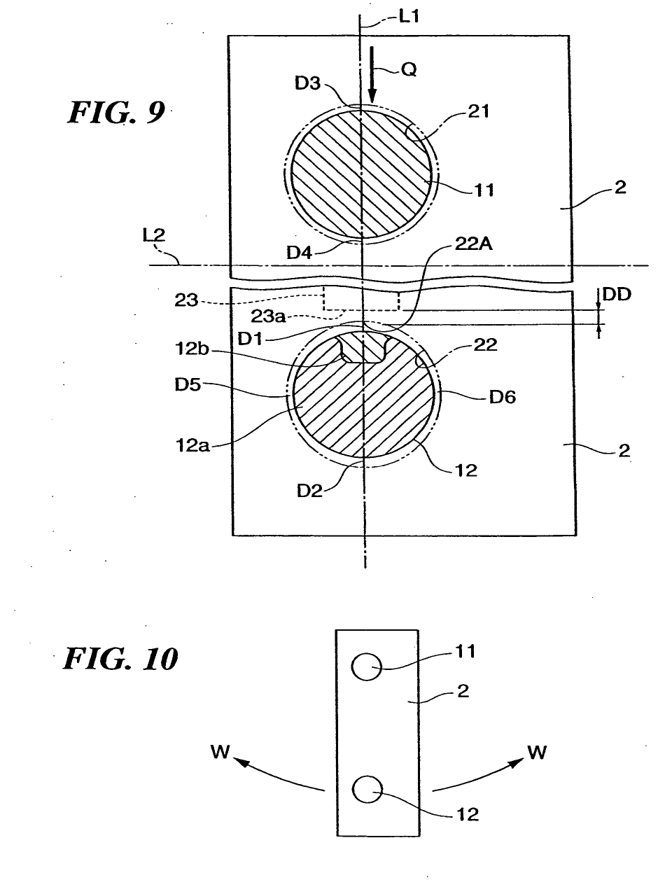

FIG. 8A is a perspective view showing a main part of the moving block 2, and FIG. 8B is a sectional view of the auxiliary moving guide element 12 in FIG. 8A. FIG. 9 is a view explaining a clearance between a partial side surface of the moving block 2 and the main moving guide element 11 and the auxiliary guide element 12. In FIG. 9, the clearance is overdrawn. The moving block 2 is molded of resin, and is constructed by a square-shaped frame body 2a and a board mounting part 2b. In opposing portions 2a1 and 2a1 of the frame body 2a of the moving block 2, main guide holes 21 and 21 in which the main moving guide 11 is inserted are formed at an upper side, and auxiliary guide holes 22 and 22 in which the auxiliary moving guide element 12 is inserted are respectively formed at the lower side. A board 24 to which a magnetic sensor 23 as a detecting part is fastened is mounted to the board mounting part 2b, and a flat cable 25 is connected to the board 24.

The auxiliary moving guide element 12 is constructed by a shaft (main part) 12a in the shape of a substantially round bar which is formed by profile drawing of non-magnetic stainless steel, and a magnetic member (auxiliary part) 12b filled in a grove 12c which is formed in a longitudinal direction of the shaft 12a. As shown in FIG. 8B, the depth of the groove 12c is about a quarter of the diameter of the shaft 12a, and outer peripheral edge portions 12c1 of the groove 12c are formed with roundness. Thereby, a gap is prevented from occurring between the magnetic member 12b and the shaft 12a due to sink or the like after insert molding of the magnetic member 12b. The shaft 12a is non-magnetic, but the magnetic member 12b is made by mixing (kneading) a PPS resin (poly phenylene sulfide resin) and ferrite particles. Marking treatment by magnetizing from an opposed surface 12A opposed to the magnetic sensor 23 of the auxiliary moving guide element 12 is applied to the magnetic member 12b. Namely, magnetic poles are formed in the longitudinal direction on the magnetic member 12b by alternately polarizing the north pole and the south pole at the intervals (pitches) of, for example, 330 μm. This is a so-called “magnescale (magnetized scale)” as in each of the above described embodiments. The magnetic member 12b is formed by mixing PPS and a ferrite resin, and therefore, it is high in magnetic coercive force and less expensive.

The magnetic sensor 23 includes two magnetic resistance elements (MR elements), and as shown by the broken line, for example, in FIG. 9, the magnetic sensor 23 is provided so that its guide element opposing part 23a is spaced from the auxiliary guide hole 22 by a predetermined distance DD. When the moving block 2 moves along the main moving guide element 11 and the auxiliary moving guide element 12, the magnetic sensor 23 senses the magnetic pole of the magnetic member 12b and outputs a signal. The magnetic pole of the magnetic member 12b is constructed by two rows having a phase difference, and the detection principle by this magnetic sensor 23 is the same as in the first embodiment which uses the above described magnetic sensor 71 and the like.

As shown in FIG. 9, the sectional shapes of the main moving guide element 11, the main guide hole 21 and the auxiliary moving guide element 12 are complete round, but the sectional shape of the auxiliary guide hole 22 is in an elliptical shape slightly longer vertically along the direction of a line L1 connecting the centers of the main guide hole 21 and the auxiliary guide hole 22. In this embodiment, the direction of the above described line L1 is called a “vertical direction” and the direction of a line L2 perpendicular to the line L1 is called a “lateral direction”.

The dimensions in the fourth embodiment are as follows. The diameters of the main moving guide element 11 and the auxiliary moving guide element 12 are both 4.0 mm, the diameter of the main guide hole 21 is 4.1 mm, the diameter (short diameter) in the lateral direction of the auxiliary guide hole 22 is 4.1 mm, and the diameter (long diameter) in the vertical direction of the auxiliary guide hole 22 is 4.3 mm.

The direction of the pressure applied when operating the moving block 2 to move is the direction of an arrow Q in FIG. 9, and a clearance (D1+D2) in the pressing direction Q between the auxiliary guide hole 22 and the auxiliary moving guide element 12 is larger than a clearance (D3+D4) in the pressing direction Q between the main guide hole 21 and the main moving guide element 11. Accordingly, for example, when the pressing force is strong, bending is likely to occur to the main moving guide element 11, but even if the bending occurs, the upper edge 22A of the auxiliary guide hole 22 does not contact the magnetic member 12b, and wear and the like of the magnetic member 12b can be prevented.

Since the guide element opposing part 23a of the magnetic sensor 23 also separates from the upper edge 22A of the auxiliary guide hole 22 by the distance DD, the guide element opposing part 23a does not contact the magnetic member 12b, and in this case, the guide element opposing part 23a of the magnetic sensor 23 approaches the magnetic member 12b and acts so that the sensing ability of the magnetic field of the magnetic member 12b by the magnetic sensor 23 is enhanced. Therefore, setting the sensing ability of the magnetic sensor 23 at a predetermined value in the normal state without bending in the main moving guide element 11 would increase sensitivity of the magnetic sensor 23 on the other hand when the above described bending occurs, and there would be no influence on detection accuracy.

As for the above described relationship of the clearances, the clearance (D3+D4) in the pressing direction Q between the main guide hole 21 and the main moving guide element 11 is made smaller than the clearance (D1+D2) in the pressing direction Q between the auxiliary guide hole 22 and the auxiliary moving guide element 12 on the other hand, and by the main guide hole 21 and the main moving guide element 11, back-lash in the pressing direction to the moving block 2 is eliminated to make operability of the slide operation favorable Further, a clearance (D5+D6) of the lateral direction L2 between the auxiliary guide hole 22 and the auxiliary moving guide element 12 is the same (may be about the same) as the clearance (D3+D4) between the main guide hole 21 and the main moving guide element 11, and swing (arrows W) in the lateral direction of the moving block 2 as shown in FIG. 10 can be prevented. Since the moving guide part comprised of the two bars of the main moving guide element 11 and the auxiliary moving guide element 12 which are parallel with each other is included like this, the slide operation of the moving block 2 is stabilized, and an influence on the sensor detection accuracy of the magnetic sensor 23 by the pressing force at the time of operation can be further reduced. In the fourth embodiment, the guide element opposing part 23a of the magnetic sensor 23 faces downward, and therefore, an influence of dust and the like on the guide element opposing part 23a can be prevented.

The reason why the main moving guide element 11 is “main” is that the main moving guide element 11 prevents swings in the vertical direction and the lateral direction of the moving block 2, and the reason why the auxiliary moving guide element 12 is “auxiliary” is that the auxiliary moving guide element 12 prevents only swing in the lateral direction of the moving block 2. Since these guide elements are two bars, the contact area with the moving block is smaller than the case where the moving block is guided with a guide having, for example, a height corresponding to the vertical distance between the two bars, namely, there is less wear, and smooth slide operation can be performed. In addition, the guide members become light, which results in reduction in weight of the entire device.

Here, in the fourth embodiment, the auxiliary moving guide element 12 is constructed by a stainless steel shaft 12a which is the main part and the magnetic member 12b which is the auxiliary part, but the upper main moving guide 11 may be constructed by the stainless steel shaft that is the main part and the magnetic member as in a subsequent fifth embodiment. A sectional view of a main moving guide element in the fifth embodiment is shown in FIG. 6B. Namely, a main moving guide 411 which penetrates through the shaft hole (guide hole) 51a″ formed in the guide holding part 5a″ of the moving block 51″ in FIG. 6B is constructed by a stainless steel shaft 411a and a magnetic member 411b. This construction is the same as the shaft 12a and the magnetic member 12b in the fourth embodiment. The magnetic member 411b is disposed at the lower side, and the magnetic sensor 23 (the same as in the fourth embodiment) is disposed to opposed to an opposing surface 411A of the magnetic member 411b. In this case, if the pressing force is applied at the time of operation, a gap G1 is enlarged, but by accurately making a clearance between the main moving guide 411 and the shaft hole 51a″, a change in the gap G1 is made small so as not to affect detection accuracy. Since in the fifth embodiment, though not shown, an auxiliary guide hole and an auxiliary moving guide only have to have the function of preventing lateral swing shown in the above described FIG. 10, the auxiliary guide hole is made vertically longer as the hole with the line L1 direction in FIG. 9 as the longitudinal direction, and they can be roughly designed.

In the above described fourth and fifth embodiments, the light emitting element by LEDs or the like may be provided at the slider as in each of the above described embodiments. In the slide volume device in the fourth embodiment, it is the same as in the first embodiment that the emitting light colors of the multi-color LED element is controlled by the circuits in FIG. 12 or FIG. 13, and recognition of the function set at each of the slide volume devices can be facilitated. Namely, the slide volume device which is constructed by the magnetic sensor 23, the magnetic member 12b (auxiliary moving guide element 12) and the circuit which processes an output signal of the magnetic sensor 23 in the fourth embodiment corresponds to the volume circuit V1 in FIGS. 12 and 13. Further, the light emitting element by LEDs or the like used in the fourth embodiment corresponds to the multi-color LED element 54 in FIG. 12, or the red LED 54a, the green LED 54b and the blue LED 54c in FIG. 13, and the driving current to these LEDs are supplied from the flat cable 25 connected to the board 24. Further, the flat cable 25 in the fourth embodiment is also constructed to be drawn from the drawing port as the above described lead wire drawing port 311, and can be lightly fixed at the portion of the drawing port. In this case, even if the moving block 2 moves, the flat cable 25 is not dangling as the cable connected to the head of an ordinary printer when seen from outside the side plate, and therefore, the flat cable 25 can be favorably housed in the apparatus of the slide volume device.

The above described respective embodiments are the examples which realize the non-contact method by the magnetic method, but non-contact method may be realized by an optical method. In this case, for example, constant cycle patterns in a white and black bar cord shape are formed in two rows on the undersurface of the second moving guide 42 (surface corresponding to the magnetic surface 43a) in the example of FIG. 1A, and on the undersurfaces of the moving guides 41′ and 41″ (the surfaces corresponding to the magnetic surfaces 41a′ and 41a″) in the examples of FIGS. 3A and 6A, for example, and a photosensor constructed by a light-emitting diode, a photodiode and the like is provided instead of the magnetic sensors 71, 71′, 71″ and 23, so that the pulse signals having the above described phase difference corresponding to the two rows by the above described white and black pattern are obtained. In the case of the optical method, energization of the multi-color LED elements 54, 54′ and 54″ and energization of the photosensor are performed by the flat cables 91, 91′ and 91″. Since in this case, the second moving guide 42, and the first moving guides 41′ and 41″ themselves which are engaged with the moving block at which the photosensor is arranged are sensed by the photosensor, even if the pressing force occurs, the clearance (gap) between the photosensor and the pattern surface can be kept constant, and detection accuracy is ensured as in the above described magnetic method

In any case of the magnetic method or the optical method, at the time of operation, the abutting part 51e or the guide holding parts 5a and 5a″, and the main guide hole 21 in the fourth embodiment work as the stoppers in the pressing direction (the arrow Q direction), the position in the pressing direction of the moving block 51 to the second moving guide 42, the positions in the pressing direction of the moving blocks 51′ and 51″ to the moving guides 41′ and 41″ are respectively restricted to be constant. Therefore, operation feeling (sliding feeling) is improved and the measure against the vertical load to the entire device can be taken.

The material of the moving guide which constructs the sensing device with the sensor (detecting part) is preferably the material in the above described respective embodiments, but the present invention is not limited to this.

What is claimed is:

1. A slide control device having a fixed part and a moving part moving with respect to said fixed part, and outputting a moving signal by movement of said moving part with respect to said fixed part, comprising:
a moving guide that is provided at said fixed part along a longitudinal direction of the fixed part, and slidably holds said moving part; and
a sensing device that senses an operation state in which said moving part moves along said moving guide, wherein:
said sensing device has a detecting part that is provided at said moving part, senses said moving guide, and outputs the moving signal; and
said detecting part orients in an opposite direction to a direction to press said moving part when said moving part is moved.

2. The slide control device according to claim 1,
wherein a marking treatment part on which a number of polarized magnetic poles are formed in a longitudinal direction of the moving guide is included in said moving guide, and
said detecting part is a magnetic sensor that detects a magnetic field of the magnetic poles of the marking treatment part.

3. The slide control device according to claim 1,
wherein a marking treatment part on which a dark and light pattern is formed in a longitudinal direction of the moving guide is included in said moving guide, and
said detecting part is an optical sensor that optically detects a change in the pattern of the marking treatment part.

4. The slide control device according to claim 1,
wherein a light emitting element is provided at a slider mounted to said moving part.

5. The slide control device according to claim 1,
wherein a lead wire drawing port from which a lead wire connected to said detecting part is drawn out is provided in a center of said moving part with respect to a moving direction thereof.

6. A slide control device having a fixed part and a moving part moving with respect to said fixed part, and outputting a moving signal by movement of said moving part with respect to said fixed part, comprising:
a moving guide that is provided at said fixed part, and holds said moving part slidably along a longitudinal direction of said fixed part; and
a detecting part that is provided at said moving part and senses the moving guide when said moving part moves in a longitudinal direction of the moving guide by being guided by said moving guide, wherein:
said moving part has an abutting part that abuts on said moving guide in a direction to press the moving part when the moving part is moved; and
said detecting part is provided at said moving part to be opposed to the direction to press the moving part when said moving part is moved.

7. A slide control device comprising a main body part fixed to an electronic apparatus, and a moving part moved with respect to said main body part, and having a detector that outputs a moving signal by said moving part moving, comprising:
moving guide part of two bars comprising a first moving guide element and a second moving guide element that are fixed to said main body part and parallel with each other along a longitudinal direction of said main body part, wherein
any one of said first and second moving guide elements has a marking treatment part to which marking treatment is applied in its longitudinal direction as a part of the detector;
a detecting part that generates the moving signal by the moving part being moved while opposing said marking treatment part by moving in a longitudinal direction of the moving guide part by being guided by said moving guide part is provided at said moving part;
said detecting part has a moving guide element opposing part that is opposed to said any one of the moving guide elements; and
said any one of the moving guide elements has said marking treatment applied to an opposing surface to the moving guide element opposing part of said detecting part along its longitudinal direction.

8. The slide control device according to claim 7, wherein said detecting part is provided at said moving part to be opposed to a direction to press said moving part when said moving part is moved.

9. The slide control device according to claim 7, wherein
said moving part has a first guide hole that allows said any one of the moving guide elements to penetrate therethrough, and a second guide hole that allows said other moving guide element to penetrate therethrough; and
a clearance in a pressing direction between said first guide hole and the moving guide part is larger than a clearance in the pressing direction between said second guide hole and the moving guide part.

10. The slide control device according to claim 7, wherein said any one of the moving guide elements comprises a main part with a non-magnetic element in a bar shape having rigidity as a main shaft, and an auxiliary part as a marking treatment part to which a magnetized scale provided along a longitudinal direction of the main part is applied.
